(19) United States
(12) Patent Application Publication
(10) Pub. No.: US 2025/0309599 A1
(43) Pub. Date: Oct. 2, 2025

(54) ADAPTER

(71) Applicant: Lexar Electronics (Shenzhen) Co., Ltd., SHENZHEN (CN)

(72) Inventors: Zutao QIU, SHENZHEN (CN); Jinbiao CHEN, SHENZHEN (CN); Youhua MA, SHENZHEN (CN)

(73) Assignee: Lexar Electronics (Shenzhen) Co., Ltd., SHENZHEN (CN)

(21) Appl. No.: 19/073,268

(22) Filed: Mar. 7, 2025

(30) Foreign Application Priority Data
Mar. 28, 2024 (CN) 202420633086.0

(51) Int. Cl. H01R 31/06; H01R 13/506

(52) U.S. Cl. CPC H01R 31/065; H01R 13/506

(57) ABSTRACT

An adapter includes: an adapter body, arranged with a first connector and a second connector. The first connector is configured to be connected to a first connection object, and the second connector is configured to be connected to a second connection object. The adapter body is arranged with at least one fixation member to fix the second connection object.

### CROSS REFERENCE TO RELATED APPLICATIONS

The present application claims the priority of the Chinese patent application No. 202420633086.0, filed on Mar. 28, 2024, the entire contents of which are hereby incorporated by reference in their entireties.

### TECHNICAL FIELD

The present disclosure relates to the technical field of adapter structures, and in particular to an adapter.

### BACKGROUND

For a user who uses various intelligent devices, adapters may be applied in various scenarios.

Various electronic devices may be connected to each other through the adapter, and various functions can be achieved. However, stability of topology of the adapter being connected to various electronic devices is a problem that needs to be solved.

### SUMMARY OF THE DISCLOSURE

The present disclosure provides an adapter to improve stability of the adapter being connected to various electronic devices.

In a first aspect, the present disclosure provides an adapter, including: an adapter body, arranged with a first connector and a second connector. The first connector is configured to be connected to a first connection object, and the second connector is configured to be connected to a second connection object. The adapter body is arranged with at least one fixation member to fix the second connection object.

In some embodiments, the at least one fixation member includes a mortise groove, defined in each of two opposite sides of the adapter body; the second connection object is arranged with a tenon corresponding to the mortise groove. When the second connection object is connected to the second connector, the mortise groove in each of the two opposite sides of the adapter body is correspondingly mated and snapped with the tenon on the second connection object.

In some embodiments, the at least one fixation member includes a tenon, arranged on each of two opposite sides of the adapter body; and a mortise groove is correspondingly defined in the second connection object. When the second connection object is connected to the second connector, the tenon on each of the two opposite sides of the adapter body is correspondingly mated and snapped with the mortise groove in the second connection object.

In some embodiments, the at least one fixation member includes at least one fixation hole, defined in an edge of a target surface of the adapter; at least one fixation pin is correspondingly arranged on the second connection object. When the second connection object is connected to the second connector, each of the at least one fixation pin on the second connection object is correspondingly inserted in a respective one of the at least one fixation hole at the edge of the target surface for fixing.

In some embodiments, a shape of the at least one fixation hole is the same as a shape of the at least one fixation pin; and the shape includes one or more of: a circular shape, a triangular shape, a rectangular shape, a trapezoidal shape, and a stepped shape.

In some embodiments, the at least one fixation member includes a magnetic adsorption anode, the magnetic adsorption anode is disposed at an edge of a target surface of the adapter; the second connection object is arranged with a magnetic adsorption cathode corresponding to the magnetic adsorption anode. When the second connection object is connected to the second connector, the magnetic adsorption cathode on the second connection object is correspondingly adsorbed to the magnetic adsorption anode on the edge of the target surface for fixing. Alternatively, the at least one fixation member includes a magnetic adsorption cathode, the magnetic adsorption cathode is disposed at an edge of a target surface of the adapter; the second connection object is arranged with a magnetic adsorption anode corresponding to the magnetic adsorption cathode. When the second connection object is connected to the second connector, the magnetic adsorption anode on the second connection object is correspondingly adsorbed to the magnetic adsorption cathode on the edge of the target surface for fixing.

In some embodiments, the adapter body further includes a housing and a circuit board; the housing defines a receiving cavity, and the circuit board is disposed inside the receiving cavity. An end of the first connector is connected to the circuit board inside the receiving cavity, and the other end of the first connector extends through a target surface of the housing to be exposed to be connected to the first connection object. An end of the second connector is connected to the circuit board inside the receiving cavity, the other end of the second connector extends through the target surface of the housing to be exposed to be connected with the second connection object. The at least one fixation member is disposed on the housing.

In some embodiments, the target surface of the housing defines a first through hole and a second through hole; the first connector extends through the first through hole to be connected to the first connection object, the second connector extends through the second through hole to be connected with the second connection object. An inner wall of the first through hole is in contact with the first connector, and an inner wall of the second through hole is in contact with the second connector.

In some embodiments, a protrusion is arranged at and protrudes from a peripheral edge of a side of the first through hole away from the circuit board; and the protrusion is arranged to be mated with the first connection object.

In some embodiments, the first connection object is a smart mobile terminal, and the second connection object is a storage device. The first connector and the second connector are disposed in parallel with and are spaced apart from each other, and each of the first connector and the second connector is: a High Definition Multimedia Interface connector, a Type-C female connector, a Type-C male connector, or a DisplayPort connector.

According to the present disclosure, the adapter includes an adapter body, the adapter body is arranged with a first connector and a second connector. The first connector is configured to be connected with a first connection object, and the second connector is configured to be connected with a second connection object. The adapter body is arranged with at least one fixation member to fix the second connection object. In this way, stability and reliability of the entire topology, after the adapter being connected with the first connection object and the second connection object, are improved; and a case that the second connection object is loosened when the adapter is connected to both the first connection object and the second connection object, may be avoided.

### BRIEF DESCRIPTION OF THE DRAWINGS

FIG. 1 is a structural schematic view of an adapter according to a first embodiment of the present disclosure.

FIG. 2 is an exploded view of the adapter according to the first embodiment of the present disclosure.

FIG. 3 is a cross-sectional view of the adapter according to the first embodiment of the present disclosure.

FIG. 4 is a cross-sectional view of the adapter according to a second embodiment of the present disclosure.

FIG. 5 is a cross-sectional view of the adapter according to a third embodiment of the present disclosure.

FIG. 6 is a cross-sectional view of the adapter according to a fourth embodiment of the present disclosure.

### DETAILED DESCRIPTION

The technical solutions in the embodiments of the present disclosure will be described clearly and completely in the following by referring to the accompanying drawings in the embodiments of the present disclosure. Apparently, the described embodiments are only a part of, not all of, the embodiments of the present disclosure. All other embodiments, which are obtained by any ordinary skilled person in the art based on the embodiments in the present disclosure without making creative work, shall be within the scope of the present disclosure.

It should be noted that directional indications (such as up, down, left, right, front, rear . . . ) are only used to explain a relative positional relationship and movement between components in a particular attitude (the attitude as shown in the drawings), and when the particular attitude changes, the directional indications may be changed accordingly.

In addition, terms “first”, “second”, and so on are used only for the purpose of description and shall not be interpreted as indicating or implying relative importance or implicitly specifying the number of indicated technical features. Therefore, a feature defined by the “first” or “second” may explicitly or implicitly include at least one such feature. In addition, technical solutions of various embodiments can be combined with each other, but the combination must be achievable by any ordinary skilled person in the art. When combination of some technical solutions is contradictory or unachievable, the combination of the technical solutions does not exist and is not included in the scope of the present disclosure.

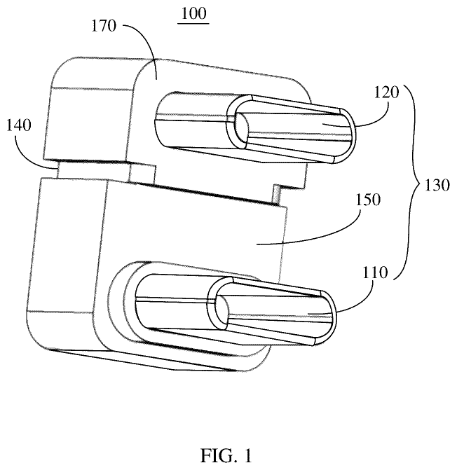

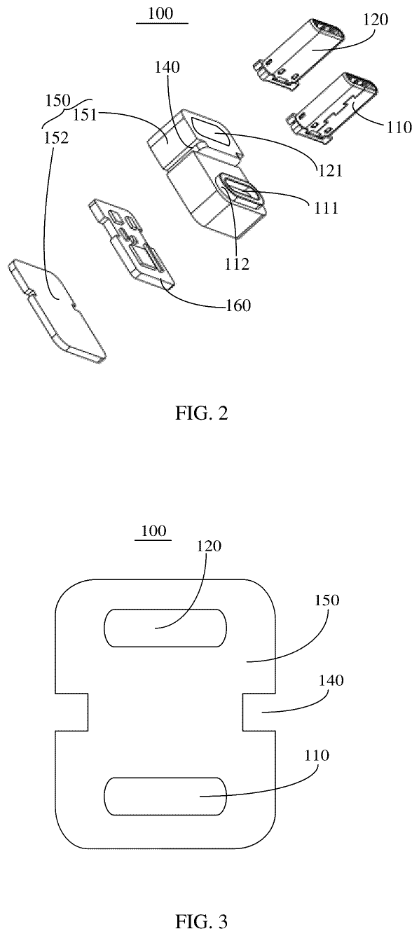

As shown in FIGS. 1 to 3, FIG. 1 is a structural schematic view of an adapter according to a first embodiment of the present disclosure; FIG. 2 is an exploded view of the adapter according to the first embodiment of the present disclosure; and FIG. 3 is a cross-sectional view of the adapter according to the first embodiment of the present disclosure.

The adapter 100 of the present embodiment includes an adapter body 130, and the adapter body 130 is arranged with a first connector 110 and a second connector 120. The first connector 110 is connected to a first connection object (not shown in the drawings); and the second connector 120 is connected to a second connection object (not shown in the drawings).

The first connection object and the second connection object are external connection objects connected to the adapter 100. The first connecting object and the second connecting object are connected which the adapter 100. A size of the second connection object may be smaller than a size of the first connection object. In an application scenario, the first connection object may be a smart mobile terminal, and the second connection object may be a storage device. The smart mobile terminal and the storage device are connected via the adapter 100, such that an external memory is provided for the smart mobile terminal. In an application scenario, the first connection object may be a camera, and the second connection object may be a flash, and the camera and the flash are connected to each other via the adapter 100, such that flashing is provided for the camera. In an application scenario, the first connection object may be a computer host, and the second connection object may be a storage device or an audio device, the computer host may be connected to the storage device or the audio device via the adapter 100, such that an external memory or an audio playing function may be provided for the computer host. Specific types of the first connection object and the second connection object are not limited herein. In other embodiments, the size of the second connection object may alternatively be equal to or greater than the size of the first connection object. The sizes of the first connection object and the second connection object may be determined based on the actual situations.

The adapter body 130 is arranged with at least one fixation member 140 to fix the second connection object having the smaller size. In this way, stability and reliability of the entire topology after the adapter 100 being connected to the first connection object 110 and the second connection object 120 may be improved.

The number of the at least one fixation member 140 may be one or more, and the number may be determined based on actual needs.

In an application scenario, fixation by the at least one fixation member 140 may include, but is not limited to: mortise and tenon fixation, thread fixation, magnetic attraction fixation, or adhesive fixation.

According to the above structure, the adapter of the present embodiment includes the adapter body, the adapter body is arranged with the first connector and the second connector. The first connector is configured to be connected with the first connection object, and the second connector is configured to be connected with the second connection object. The size of the second connection object is smaller than the size of the first connection object. The adapter body is arranged with at least one fixation member to fix the second connection object having the smaller size. In this way, stability and reliability of the entire topology, after the adapter being connected with the first connection object and the second connection object, are improved; and the case that the second connection object is loosened when the adapter is connected to both the first connection object and the second connection object, may be avoided.

In some embodiments, the at least one fixation member 140 includes a mortise groove, defined in each of two opposite sides of the adapter body 130, and a tenon is arranged on the second connection object corresponding to the mortise groove. When the second connection object is connected to the second connector 120, the tenon arranged on the second connection object is correspondingly snapped with the mortise groove defined in each of the two opposite sides of the adapter body 130. The second connection object is secured by correspondingly connecting a concave member and a convex member, such that structural stability between the second connection object and the adapter 100 is improved.

In some embodiments, the adapter body 130 further includes a housing 150 and a circuit board 160. The housing 150 is configured to support the entire adapter body 130. The circuit board 160 is a master control board of the adapter 100.

The housing 150 defines a receiving cavity (not labeled in the drawings), and the circuit board 160 is disposed in the receiving cavity. An end of the first connector 110 is connected to the circuit board 160 in the receiving cavity; and the other end of the first connector 110 extends through a target surface 170 of the housing 150 to be exposed to be connected to the first connection object. An end of the second connector 120 is connected to the circuit board 160 in the receiving cavity, the other end of the second connector 120 extends through the target surface 170 of the housing 150 to be exposed to be connected with the first connection object. The first connector 110 and the second connector 120 are spaced apart from each other without interference with each other. The at least one fixation member 140 is arranged on the housing 150. A specific position where the at least one fixation member 140 is arranged on the housing 150 may be determined accordingly based on a type of the at least one fixation member 140.

The housing 150 includes a housing case 151 and a cover plate 152, and the cover plate 152 is fixedly arranged to an opening of the housing case 151, such that the housing 150 having the receiving cavity is formed.

The target surface 170 is a surface of the adapter 100 disposed near the first connection object and the second connection object. When the adapter 100 takes the first connector 110 to be connected to the first connection object and takes the second connector 120 to be connected to the second connection object, the first connection object and the second connection object are both in contact with the target surface 170. In this case, the first connection object, the first connector 110, the circuit board 160, the second connector 120, and the second connection object are connected to each other in sequence.

In some embodiments, a first through hole 111 and a second through hole 121 are defined in the target surface of the housing 150. The first connector 110 extends through the first through hole 111 to be connected to the first connection object. The second connector 120 extends through the second through hole 121 to be connected to the second connection object. An inner wall of the first through hole 111 is in contact with the first connector 110, and an inner wall of the second through hole 121 is in contact with the second connector 120. That is, a size of the first through hole 111 matches a size of the first connector 110; and a size of the second through hole 121 matches a size of the second connector 120.

In some embodiments, a protrusion 112 is arranged at and protrudes from a peripheral edge of a side of the first through hole 111 away from the circuit board 160. The protrusion 112 is arranged to be mated with the first connection object. Since the first connection object may be an intelligent electronic device made in any manufacturer, the size of the first connection object may be finely tuned according to application scenarios of the intelligent electronic device, such that the size of the first connection object may not match the standard size of the first connector 110. Therefore, in the present embodiment, the protrusion 112 is arranged to prevent the mismatching, the first connector 110 may take the protrusion 112 to be mated with the first connection object, such that stability and reliability of the connection may be improved.

When the second connection object also meets the same situation as described in the above, another protrusion may be arranged at and protrudes from a peripheral edge of a side of the second through hole 121 away from the circuit board 160. The arrangement may be determined based on actual needs.

In some embodiments, the first connection object is the intelligent mobile terminal, and the second connection object is the storage device. The adapter of the present embodiment may be applied to a scenario in which a user of the intelligent mobile terminal wishes to store data to an external storage device while capturing images and wishes to provide a microphone for audio inputting or provide an adapter for charging during capturing images.

The first connector 110 and the second connector 120 are disposed in parallel and spaced apart from each other. The first connector 110 and the second connector 120 may be: a High Definition Multimedia Interface (HDMI) connector, a Type-C female connector, a Type-C male connector, or a DisplayPort (DP) connector. Specific types of the first connector 110 and the second connector 120 may be determined based on actual needs.

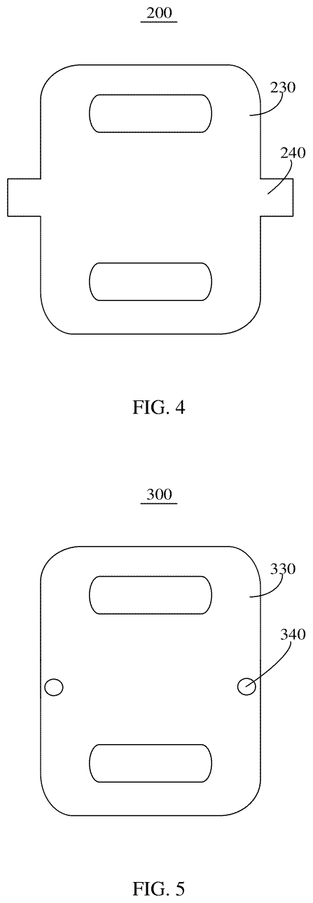

As shown in FIG. 4, FIG. 4 is a cross-sectional view of the adapter according to a second embodiment of the present disclosure.

In the present embodiment, the first connector, the second connector, the adapter body, the housing, the circuit board, and other configuration of the adapter 200 of the present embodiment are the same as those described in the previous embodiment, which will not be repeated herein.

The at least one fixation member 240 of the present embodiment includes the tenon. The tenon is disposed on each of two opposite sides of the adapter body 230. The mortise groove is correspondingly defined in the second connection object. When the second connection object is fixed with the adapter body 230, the tenon on each of the two opposite sides of the adapter body 230 is fixed with by being snapped with the mortise groove defined in the second connection object. In this way, the smaller sized second connection object is fixed; stability and reliability of the entire topology, after the adapter being connected with the first connection object and the second connection object, are improved; and the case that the second connection object is loosened when the adapter 200 is connected to both the first connection object and the second connection object, may be avoided.

As shown in FIG. 5, FIG. 5 is a cross-sectional view of the adapter according to a third embodiment of the present disclosure.

The first connector, the second connector, the adapter body, the housing, the circuit board, and other configuration of the adapter 300 of the present embodiment are the same as those as described in the previous embodiment, which will not be repeated herein.

The at least one fixation member 340 includes at least one fixation hole, located at an edge of the target surface of the adapter 300. At least one fixation pin is correspondingly arranged on the second connection object. When the second connection object is fixed with the adapter body 330, each of the at least one fixation pin on the second connection object is correspondingly inserted in a respective one of the at least one fixation hole at the edge of the target surface to fix the smaller sized second connection object. In this way, stability and reliability of the entire topology, after the adapter 300 being connected with the first connection object and the second connection object, are improved; and the case that the second connection object is loosened when the adapter 300 is connected to both the first connection object and the second connection object, may be avoided.

In an application scenario, a shape of the at least one fixation hole and a shape of the at least one fixation pin are correspondingly the same to each other, which may be one or more of: circular, triangular, rectangular, trapezoidal, or step-shaped. Specific shapes of the at least one fixation hole and the at least one fixation pin are not limited herein.

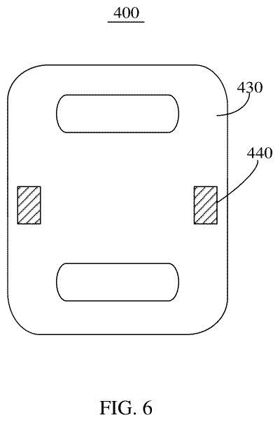

As shown in FIG. 6, FIG. 6 is a cross-sectional view of the adapter according to a fourth embodiment of the present disclosure.

The first connector, the second connector, the adapter body, the housing, the circuit board, and other configuration of the adapter 400 of the present embodiment are the same as those as described in the previous embodiments, which will not be repeated herein.

In an application scenario, the at least one fixation member 440 includes a magnetic adsorption N pole, the magnetic adsorption N pole is disposed at an edge of the target surface of the adapter 400. A magnetic adsorption S pole is correspondingly arranged on the second connection object. When the second connection object is connected to the second connector 120, the magnetic adsorption S pole on the second connection object is correspondingly adsorbed to the magnetic adsorption N pole at the edge of the target surface to fix the smaller sized second connection object. In this way, stability and reliability of the entire topology, after the adapter 400 being connected with the first connection object and the second connection object, are improved; and the case that the second connection object is loosened when the adapter 400 is connected to both the first connection object and the second connection object, may be avoided.

The magnetic adsorption N pole at the edge of the target surface of the adapter 400 may have at least one magnetic adsorption point or may be a ring surrounding the peripheral edge of the target surface.

In an application scenario, the at least one fixation member 440 includes a magnetic adsorption S pole, which is disposed at the edge of the target surface of the adapter 400; the magnetic adsorption N pole is correspondingly arranged on the second connection object. When the second adsorption object is fixed to the adapter body 430, the magnetic adsorption N pole on the second connection object is correspondingly adsorbed to the magnetic adsorption S pole at the edge of the target surface for fixing.

The magnetic adsorption S pole at the edge of the target surface of the adapter 400 may be at least one magnetic adsorption point or may be a ring surrounding the peripheral edge of the target surface.

The at least one fixation member of the adapter may be configured as the at least one fixation member in any of the above embodiments, which may be determined based on actual needs. The present disclosure does not limit configuration of the at least one fixation member.

The above shows only embodiments of the present disclosure, and does to limit the scope of the present disclosure. Any equivalent structure or equivalent principle transformation, which are performed based on the contents of the specification and the accompanying drawings of the present disclosure and are applied directly or indirectly in other related fields, shall be equivalently included in the scope of the present disclosure.

What is claimed is:

1. An adapter, comprising:
an adapter body, arranged with a first connector and a second connector, wherein the first connector is configured to be connected to a first connection object, and the second connector is configured to be connected to a second connection object;
wherein the adapter body is arranged with at least one fixation member to fix the second connection object.

2. The adapter according to claim 1, wherein
the at least one fixation member comprises a mortise groove, defined in each of two opposite sides of the adapter body; the second connection object is arranged with a tenon corresponding to the mortise groove;
when the second connection object is connected to the second connector, the mortise groove in each of the two opposite sides of the adapter body is correspondingly mated and snapped with the tenon on the second connection object.

3. The adapter according to claim 1, wherein
the at least one fixation member comprises a tenon, arranged on each of two opposite sides of the adapter body; and a mortise groove is correspondingly defined in the second connection object;
when the second connection object is connected to the second connector, the tenon on each of the two opposite sides of the adapter body is correspondingly mated and snapped with the mortise groove in the second connection object.

4. The adapter according to claim 1, wherein
the at least one fixation member comprises at least one fixation hole, defined in an edge of a target surface of the adapter; at least one fixation pin is correspondingly arranged on the second connection object;
when the second connection object is connected to the second connector, each of the at least one fixation pin on the second connection object is correspondingly inserted in a respective one of the at least one fixation hole at the edge of the target surface for fixing.

5. The adapter according to claim 4, wherein a shape of the at least one fixation hole is the same as a shape of the at least one fixation pin; and the shape comprises one or more of: a circular shape, a triangular shape, a rectangular shape, a trapezoidal shape, and a stepped shape.

6. The adapter according to claim 1, wherein
the at least one fixation member comprises a first magnetic adsorption pole having a first polarity, the first magnetic adsorption pole is disposed at an edge of a target surface of the adapter; the second connection object is arranged with a second magnetic adsorption pole corresponding to the first magnetic adsorption pole and having a second polarity opposite to the first polarity;
when the second connection object is connected to the second connector, the second magnetic adsorption pole on the second connection object is correspondingly adsorbed to the first magnetic adsorption pole on the edge of the target surface for fixing.

7. The adapter according to claim 6, wherein the first magnetic adsorption pole has N polarity, and the second magnetic adsorption pole has S polarity.

8. The adapter according to claim 6, wherein the first magnetic adsorption pole has S polarity, and the second magnetic adsorption pole has N polarity.

9. The adapter according to claim 6, wherein a size of the first connection object is greater than a size of the second connection object.

10. The adapter according to claim 1, wherein the adapter body further comprises a housing and a circuit board; the housing defines a receiving cavity, and the circuit board is disposed inside the receiving cavity; and the at least one fixation member is disposed on the housing.

11. The adapter according to claim 10, wherein the housing comprises a housing case and a cover plate, the cover plate is fixedly connected to an opening of the housing case, the cover plate and the housing case cooperatively define the receiving cavity.

12. The adapter according to claim 10, wherein,
an end of the first connector is connected to the circuit board inside the receiving cavity, and the other end of the first connector extends through a target surface of the housing to be exposed to be connected to the first connection object.

13. The adapter according to claim 10, wherein,
an end of the second connector is connected to the circuit board inside the receiving cavity, the other end of the second connector extends through the target surface of the housing to be exposed to be connected with the second connection object.

14. The adapter according to claim 10, wherein the target surface of the housing defines a first through hole and a second through hole; the first connector extends through the first through hole to be connected to the first connection object, the second connector extends through the second through hole to be connected with the second connection object;
a size of the first through hole matches a size of the first connector; and a size of the second through hole matches a size of the second connector.

15. The adapter according to claim 14, wherein,
an inner wall of the first through hole is in contact with the first connector, and an inner wall of the second through hole is in contact with the second connector.

16. The adapter according to claim 14, wherein a protrusion is arranged at and protrudes from a peripheral edge of a side of the first through hole away from the circuit board; and the protrusion is arranged to be mated with the first connection object.

17. The adapter according to claim 1, wherein the first connection object is a smart mobile terminal, and the second connection object is a storage device;
the first connector and the second connector are disposed in parallel with and are spaced apart from each other, and each of the first connector and the second connector is: a High Definition Multimedia Interface connector, a Type-C female connector, a Type-C male connector, or a DisplayPort connector.
